(19) United States
(12) Patent Application Publication
(10) Pub. No.: US 2006/0006785 A1
(43) Pub. Date: Jan. 12, 2006

(54) Sodalime glass substrate for a surface light source device, method of manufacturing the same, surface light source device having the same and backlight assembly having the surface light source device

(75) Inventors: Ki-Yeon Lee, Suwon-si (KR); Seog-Hyun Cho, Seoul (KR); Kyeong-Taek Jung, Suwon-si (KR); Jae-Hyeon Ko, Suwon-si (KR); Dong-Hee Lee, Seoul (KR)

Correspondence Address: MAYER, BROWN, ROWE & MAW LLP, 1909 K STREET, N.W., WASHINGTON, DC, 20006, US

(73) Assignee: SAMSUNG CORNING CO., LTD.

(21) Appl. No.: 11/178,396

(22) Filed: Jul. 12, 2005

(30) Foreign Application Priority Data
Jul. 12, 2004 (KR) 10-2004-53829
Sep. 7, 2004 (KR) 10-2004-71073
Oct. 25, 2004 (KR) 10-2004-85305
Dec. 13, 2004 (KR) 10-2004-105017

(51) Int. Cl. H01J 1/62; H01J 63/04

(52) U.S. Cl. 313/491

(57) ABSTRACT

A surface light source device includes a first substrate, a second substrate and an electrode. The first and second substrate defines a discharge space into which a discharge gas is injected. The electrode applies a voltage to the discharge gas. Any one of the first and second substrates includes a sodalime glass. The sodalime glass includes an ion-exchanging layer containing potassium ions that are ion-exchanged for sodium ions. Since the surface light source device does not have the sodium ions, a discoloring of the surface light source device due to an elution of the sodium ions may be prevented. Further, the sodalime glass may have an enhanced strength.

### CROSS-REFERENCE TO RELATED APPLICATION

This application relies for priority upon Korean Patent Application Nos. 2004-53829, filed on Jul. 12, 2004, 2004-71073, filed on Sep. 7, 2004, 2004-85305, filed on Oct. 25, 2004, and 2004-105017, filed on Dec. 13, 2004, the contents of which are herein incorporated by reference in their entireties.

### BACKGROUND OF THE INVENTION

1. Field of the Invention

The present invention relates to a sodalime glass substrate for a surface light source device, a method of manufacturing the sodalime glass substrate, a surface light source device having the sodalime glass substrate, and a backlight assembly including the surface light source device. More particularly, the present invention relates to a glass substrate for a surface light source device that includes a sodalime glass, a method of manufacturing the sodalime glass substrate, a surface light source device having the sodalime glass substrate that is capable of preventing a discoloring of the surface light source device, which is caused by eluting sodium (Na) ions, and a backlight assembly including the surface light source device.

2. Description of the Related Art

In general, a surface light source device employed in a liquid crystal display (LCD) apparatus has discharge spaces therein. A discharge gas such as a mercury gas, an argon gas, etc., is injected into the discharge spaces. When a voltage is applied to the discharge gas, the discharge gas is excited to generate an ultraviolet ray. A fluorescent layer on a glass substrate that defines the discharge space is excited by the ultraviolet ray to generate a visible light.

In order to define the discharge spaces, one of the first and second substrates may be transformed to form a partition wall that is integrally formed with the one of the first and second substrates (hereinafter, referred to as “substrate-transforming method”). Alternatively, a partition wall that is separately formed from the first and second substrates may be interposed between the first and second substrates to define the discharge space between the first and second substrates (hereinafter, referred to as “partition-inserting method”).

According to the substrate-transforming method, a glass substrate is heated and compressed by mold, so that the glass substrate is transformed to have a plurality of furrows. The transformed glass substrate is combined with other glass substrate by frit. Spaces between the furrows correspond to the discharge spaces, and the furrows correspond to the partition walls.

The glass substrate employed in the substrate-transforming method includes a borosilicate glass. Since the borosilicate glass scarcely contains sodium atoms, shortening a light span of a surface light source device or decreasing a light-emitting efficiency of a fluorescent layer that is caused by blackening of a discharge space is suppressed.

However, since the borosilicate glass has a relatively high softening point of about 821° C., it is very difficult to form the discharge spaces by the substrate-transforming method using the borosilicate glass. Also, since the borosilicate glass is too expensive, a cost for manufacturing a surface light source device is too high.

Meanwhile, when a sodalime glass in place of the borosilicate glass is employed in the substrate-transforming method, a cost for manufacturing a surface light source device is reduced. However, after a surface light source device including the sodalime glass is completed, mercury and sodium in the sodalime glass are reacted with each other to generate a blackening of a discharge space. The blackening of the discharge space causes shortening a life span of the surface light source device and reducing a light-emitting efficiency of a fluorescent layer. Further, sodium in the sodalime glass is eluted to form amalgam on the sodalime glass, thereby discoloring the surface light source device.

### SUMMARY OF THE INVENTION

The present invention provides a sodalime glass substrate that includes potassium ions exchanged for sodium ions and has an enhanced strength.

The present invention also provides a method of manufacturing the above-mentioned sodalime glass substrate.

The present invention still also provides a surface light source device including the above-mentioned sodalime glass substrate.

The present invention still also provides a backlight assembly having the above-mentioned surface light source device as a light source.

A sodalime glass for a surface light source device substrate in accordance with one aspect of the present invention includes an ion-exchanging layer on a surface portion of a sodalime glass substrate. The ion-exchanging layer contains potassium (K) ions that are ion-exchanged from sodium ions

In a method of manufacturing a sodalime glass substrate for a surface light source device in accordance with another aspect of the present invention, a sodalime plate glass containing sodium ions is heated to a temperature of no less than a softening point of the sodalime plate glass. The heated sodalime plate glass is transformed using a pre-heated mold to form a sodalime glass having a plurality of discharge spaces. The sodium ions at a surface portion of the sodalime glass are exchanged for potassium ions with the sodalime glass being cooled to complete the sodalime glass substrate.

A surface light source device in accordance with still another aspect of the present invention includes a first substrate, a second substrate and an electrode. The first and second substrates define a discharge space into which a discharge gas is injected. The electrode applies a voltage to the discharge gas. Any one of the first and second substrates includes an ion-exchanging layer containing potassium ions exchanged for sodium ions.

A surface light source device in accordance with still another aspect of the present invention includes a first substrate, a second substrate and an electrode. The first and second substrates define a discharge space into which a discharge gas is injected. The electrode is provided to both side portions of the first substrate or the second substrate. An ion-exchanging layer containing potassium ions exchanged for sodium ions is formed at the both side portions of the first substrate or the second substrate.

A backlight assembly in accordance with still another aspect of the present invention includes a surface light source device, upper and lower cases, an optical sheet and an inverter. The surface light source device includes a first substrate, a second substrate facing the first substrate to define a discharge space into which a discharge gas is injected, and an electrode for applying a voltage to the discharge gas. Any one of the first and second substrates includes an ion-exchanging layer containing potassium ions exchanged for sodium ions. The upper and lower cases receive the surface light source device. The optical sheet is interposed between the surface light source device and the upper case to improve characteristics of a light emitted from the surface light source device. The inverter provides the electrode with a discharge voltage for driving the surface light source device.

A backlight assembly in accordance with still another aspect of the present invention includes a surface light source device, upper and lower cases, an optical sheet and an inverter. The surface light source device includes a first substrate, and a second substrate facing the first substrate to define a discharge space into which a discharge gas is injected. The first and second substrates include sodalime glass. An electrode for applying a voltage to the discharge gas is provided to both side portions of the first substrate or the second substrate. An ion-exchanging layer containing potassium ions exchanged for sodium ions is formed at the both side portions of the first substrate or the second substrate. The upper and lower cases receive the surface light source device. The optical sheet is interposed between the surface light source device and the upper case to improve characteristics of a light emitted from the surface light source device. The inverter provides the electrode with a discharge voltage for driving the surface light source device.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a cross sectional view illustrating a surface light source device in accordance with a second embodiment of the present invention;

FIG. 2 is a cross sectional view illustrating a surface light source device in accordance with a third embodiment of the present invention;

FIG. 3 is an enlarged cross sectional view illustrating a portion “A” in FIG. 2;

FIG. 4 is a perspective view illustrating a sodalime glass substrate of the surface light source device in FIG. 2;

FIG. 5 is a cross sectional view illustrating a surface light source device in accordance with a fourth embodiment of the present invention;

FIG. 6 is a perspective view illustrating a sodalime glass substrate of the surface light source device in FIG. 5;

FIG. 7 is a plan view illustrating a surface light source device in accordance with a fifth embodiment of the present invention;

FIG. 8 is a cross sectional view taken along a line I-I′ in FIG. 7;

FIG. 9 is a cross sectional view illustrating an electrode of a surface light source device in accordance with a sixth embodiment of the present invention; and

FIG. 10 is an exploded perspective view illustrating a backlight assembly in accordance with a seventh embodiment of the present invention.

### DESCRIPTION OF THE INVENTON

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Sodalime Glass Substrate

### EMBODIMENT 1

A sodalime glass substrate of the present embodiment contains potassium ions that are exchanged for sodium ions at a surface portion of the plate glass. An ion-exchanging solution includes a slurry solution mixed of a potassium nitrate solution and a zinc oxide powder. The potassium nitrate solution has a concentration less than a solubility of below about 10% by weight. In particular, about 1 gram of potassium nitrate and about 2,00 ml of distilled water are put in a bath. The potassium nitrate is dissolved in the distilled water at a normal temperature. About 800 grams of the zinc oxide powder having an average grain size of about 1 μm is put in the bath. The zinc oxide powder is then stirred until the zinc oxide powders sufficiently diffuse to form the slurry solution as the ion-exchanging solution.

The ion-exchanging solution is then sprayed on the plate glass having a temperature of about 440° C. to about 480° C. to form the sodalime glass substrate containing the potassium ions.

Here, when the potassium nitrate solution has a concentration of below about 10% by weight, a concentration of the potassium ions required for the ion-exchanging reaction is insufficient so that an ion-exchanging speed is too slow. Further, compressive stresses are not sufficiently generated in the surface portion of the plate glass so that the sodalime glass substrate does not have an enhanced strength. On the contrary, when the potassium solution has a concentration greater than the solubility of the potassium nitrate, the potassium nitrate is not sufficiently dissolved so that the ion-exchanging reaction is locally carried out, thereby generating non-homogeneous compressive stresses in the surface portion of the plate glass. Further, since the plate glass has a temperature of below about 440° C. or above 480° C., the ion-exchanging reaction is not effectively performed.

As described above, to effectively perform the ion-exchanging reaction, the plate glass has a temperature range of about 440° C. to about 480° C. Here, a substrate-transforming method of manufacturing a surface light source device includes heating the plate glass and cooling the plate glass. Thus, the plate glass during the cooling process experiences the temperature range. As a result, the substrate-transforming method includes the ion-exchanging reaction.

On the contrary, when a discharge space is formed using a partition-inserting method of manufacturing a surface light source device, an ion-exchanged sodalime glass substrate is previously prepared before manufacturing the surface light source device.

Surface Light Source Device

### EMBODIMENT 2

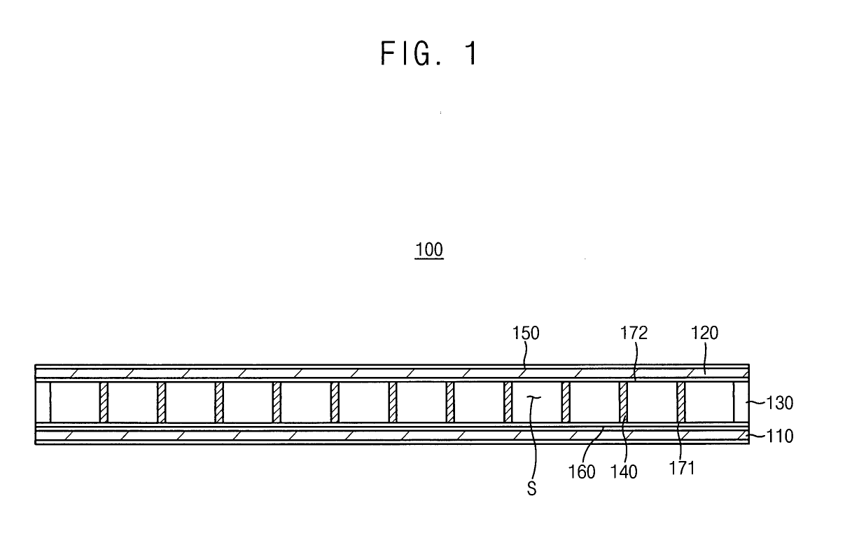

FIG. 1 is a cross sectional view illustrating a surface light source device in accordance with a second embodiment of the present invention.

Referring to FIG. 1, a surface light source device 100 of the present embodiment includes a light source body having an inner space into which a discharge gas is injected, and an electrode 150 for applying a voltage to the discharge gas. Here, the discharge gas may include a mercury gas.

The surface light source device 100 of the present embodiment corresponds to a partition wall-separated type. Thus, the light source body includes a first substrate 110, a second substrate 120 positioned over the first substrate 110, a sealing member 130 interposed between edge portions of the first and second substrates 110 and 120 to define the inner space, and partition walls 140 parallely arranged in the inner space to divide the inner space into discharge spaces S. Meanwhile, for allowing the discharge gas to flow into the discharge spaces S, the partition walls 140 may be arranged in a serpentine pattern or holes (not shown) may be formed through the partition walls 140.

A sodalime glass substrate containing potassium ions that are exchanged for sodium ions is used for the first and second substrates 110 and 120. In the present embodiment, the sodalime glass substrate is used for the second substrate 120. In addition, a sodalime glass containing potassium ions that are exchanged for sodium ions may be used as the partition walls 140.

The electrode 150 is formed on side portions of the first and second substrates 110 and 120 in a direction substantially perpendicular to a lengthwise direction of the partition walls 140. The electrode 150 may include a conductive tape, a conductive paste, etc.

A light-reflecting layer 160 is formed on the first substrate 110. The light-reflecting layers 170 reflect a light generated in the discharge spaces S, which orients toward the first substrate 110, toward the second substrate 120. A first fluorescent layer 171 is formed on the light-reflecting layer 160. A second fluorescent layer 172 is formed beneath the second substrate 120.

### EMBODIMENT 3

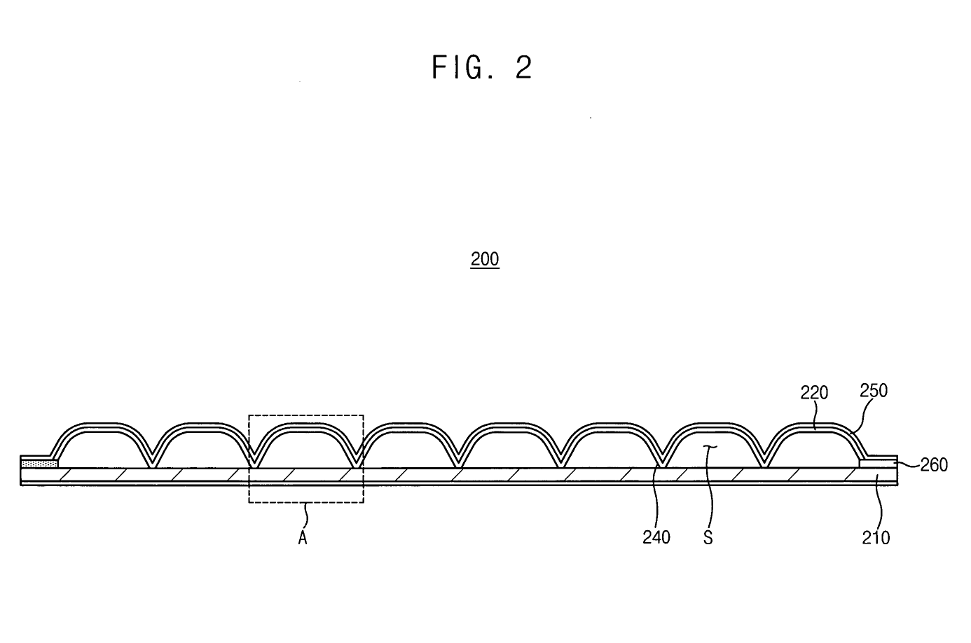

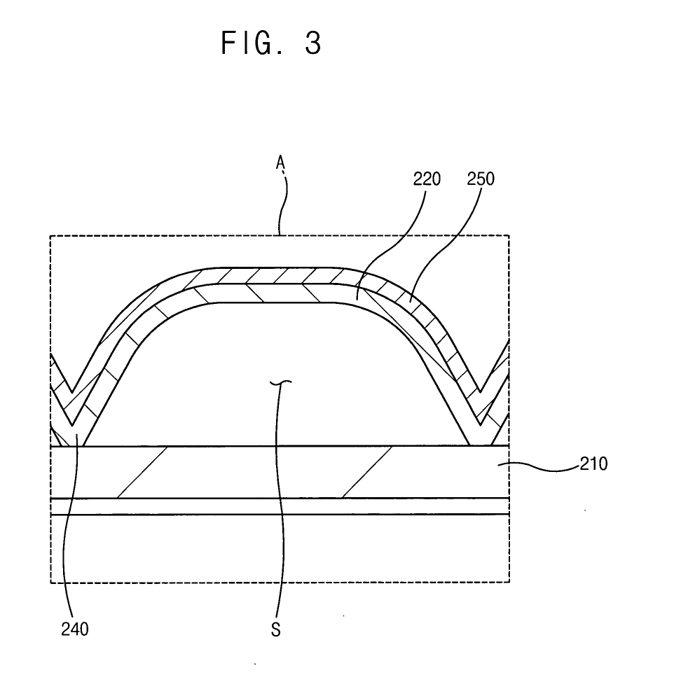

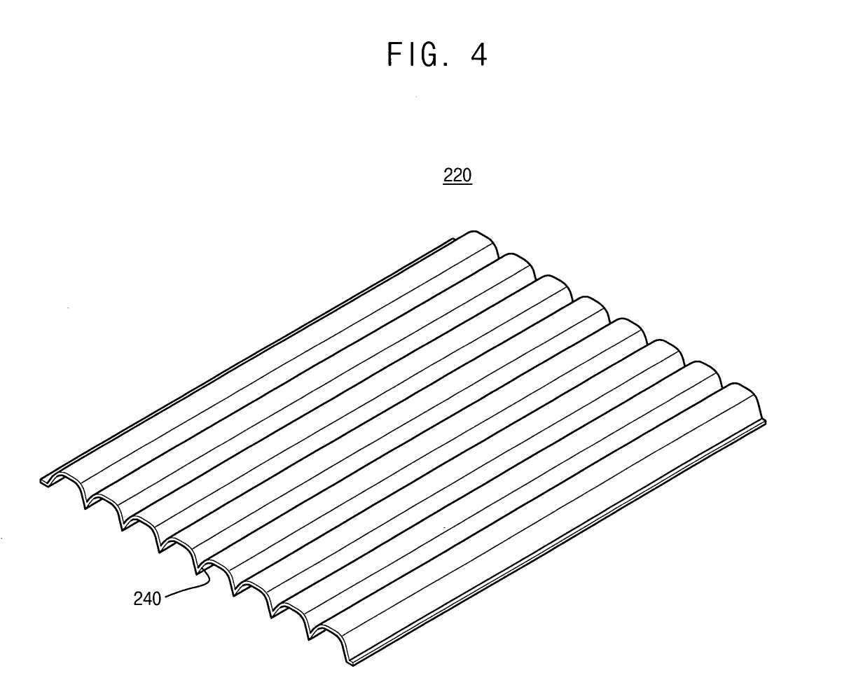

FIG. 2 is a cross sectional view illustrating a surface light source device in accordance with a third embodiment of the present invention, FIG. 3 is an enlarged cross sectional view illustrating a portion “A” in FIG. 2, and FIG. 4 is a perspective view illustrating a sodalime glass substrate of the surface light source device in FIG. 2.

Referring to FIGS. 2 to 4, a surface light source device 200 of the present embodiment includes a light source body having an inner space into which a discharge gas is injected, and an electrode 250 for applying a voltage to the discharge gas.

The surface light source device 200 of the present embodiment corresponds to a partition wall-integrated type. Thus, the light source body includes a first substrate 210, a second substrate 220 placed over the first substrate 210. The second substrate 220 is integrally formed with partition wall portions 240. The partition wall portions 240 make contact with the first substrate 210 to form a plurality of discharge spaces S. Outermost partition wall portions 240 among the partition wall portions 240 are attached to the first substrate 210 using a sealing frit 260. Here, the partition wall portions 240 may have a width of about 1 mm to about 2 mm. Meanwhile, for allowing the discharge gas to flow into the discharge spaces S, the partition wall portions 240 may be arranged in a serpentine pattern or holes (not shown) may be formed through the partition wall portions 240.

Here, to form the partition wall portions 240 integrally formed with the second substrate 220, a sodalime glass containing sodium ions is transformed. The sodium ions in the sodalime glass are exchanged for potassium ions in transforming the sodalime glass.

In particular, to transform the sodalime glass for providing the discharge spaces S, the sodalime plate glass is heated to a temperature at which the ion-exchange reaction occurs. Here, the sodalime plate glass has a softening point of about 736° C. A borosilicate glass has a softening point of about 836° C. That is, the sodalime plate glass has a softening point lower than that of the borosilicate glass by about 100° C. Thus, the sodalime plate glass may be readily transformed compared to the borosilicate glass. A pre-heated mold pressurizes the heated sodalime plate glass to form the sodalime glass substrate 220 in FIG. 4. The sodalime glass substrate 220 is slowly cooled in a slow cooling chamber. Here, when the sodalime glass substrate 220 has a temperature range of about 440° C. to about 480° C. in the cooling process, an ion-exchanging solution is sprayed on the sodalime glass substrate 220 to exchange the sodium ions in the sodalime glass substrate 220 for the potassium ions in the ion-exchanging solution. The ion-exchanging solution may be sprayed a face of the sodalime glass substrate 220 that defines the discharge spaces S.

Here, the ion-exchanging solution includes a slurry solution mixed of a potassium nitrate solution and a zinc oxide powder. The potassium nitrate solution has a concentration less than a solubility of below about 10% by weight. The zinc oxide powder has a concentration of about 15% to about 50% by weight in the potassium nitrate solution. When the zinc oxide powder has a concentration of below about 15% by weight, the zinc oxide powder does not sufficiently support potassium nitrate so that all of the sodium ions in the surface portion of the sodalime plate glass may not be exchanged for the potassium ions. On the contrary, when the zinc oxide powder has a concentration of above about 50% by weight, the ion-exchanging solution has a high viscosity so that preparing a homogeneous ion-exchanging solution may be very difficult.

After the ion-exchanging reaction is completed, the sodalime glass substrate 220 is additionally cooled, thereby completing the sodalime glass substrate 220 containing the potassium ions.

Here, since the potassium ions have a radius longer than that of the sodium ions, compressive stresses are formed in the sodalime glass substrate 220 so that the sodalime glass substrate 220 may have strength greater than that of the non-ion exchanged glass substrate.

The sodalime glass substrate containing the potassium ions is used as the second substrate 220, whereas the non-ion exchanged glass substrate containing the sodium ions may be used as the first substrate 210.

Thus, since the surface portion of the sodalime glass substrate defining the discharge spaces S contains the potassium ions exchanged for the sodium ions, amalgam caused by a reaction between sodium and mercury and by an elution of sodium may not be formed.

Meanwhile, the electrode 250 is formed on both side portions of the first and second substrates 210 and 220 in a direction substantially perpendicular to a lengthwise direction of the partition wall portions 240. In particular, the electrode 250 encloses the both side portions of the first and second substrates 210 and 220. A light-reflecting layer 260 is formed on the first substrate 210. A first fluorescent layer (not shown) is formed on the light-reflecting layer 260. A second fluorescent layer (not shown) is formed beneath the second substrate 220.

### EMBODIMENT 4

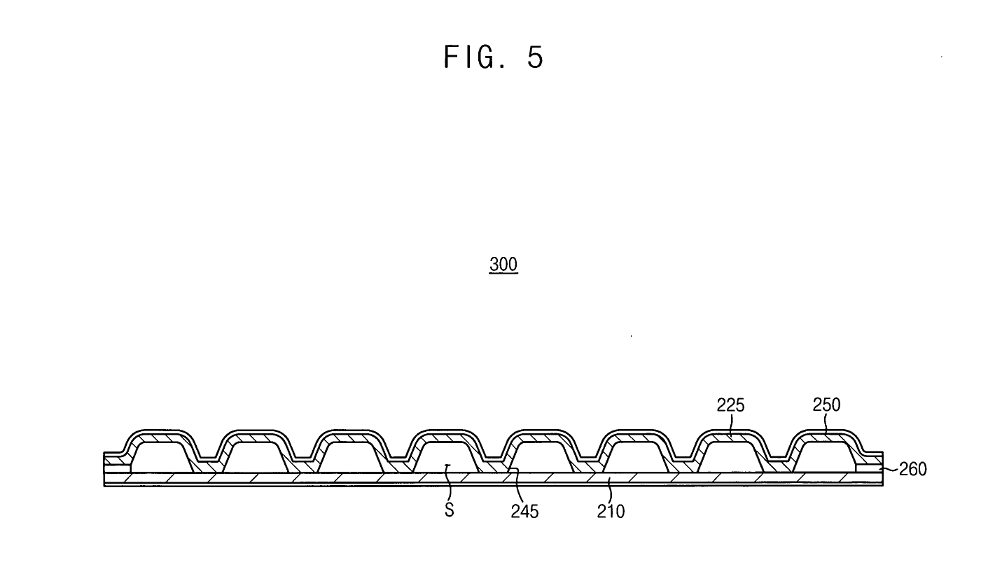

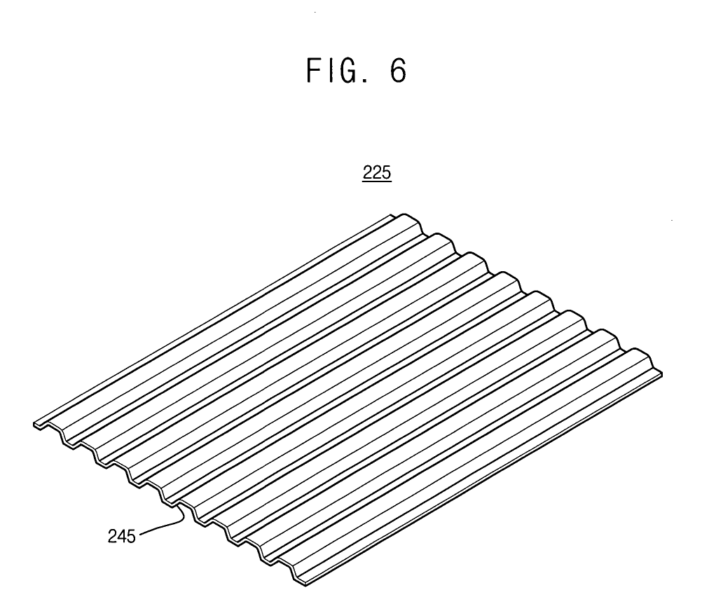

FIG. 5 is a cross sectional view illustrating a surface light source device in accordance with a fourth embodiment of the present invention, and FIG. 6 is a perspective view illustrating a sodalime glass substrate of the surface light source device in FIG. 5.

A surface light source device 300 of the present embodiment includes elements substantially identical to those in Embodiment 3 except for a second substrate. Thus, same reference numerals refer to same elements and any further illustrations with respect to the same elements are omitted herein.

Referring to FIGS. 5 and 6, partition wall portions 245 are integrally formed with a second substrate 225. To suppress a current drift between adjacent discharge spaces S, the partition wall portions 245 have a width of about 3 mm to about 5 mm, preferably about 4 mm. In addition, for allowing a discharge gas to flow into the discharge spaces S, passageways (not shown) having various shapes may be formed through the second substrate 225.

### EMBODIMENT 5

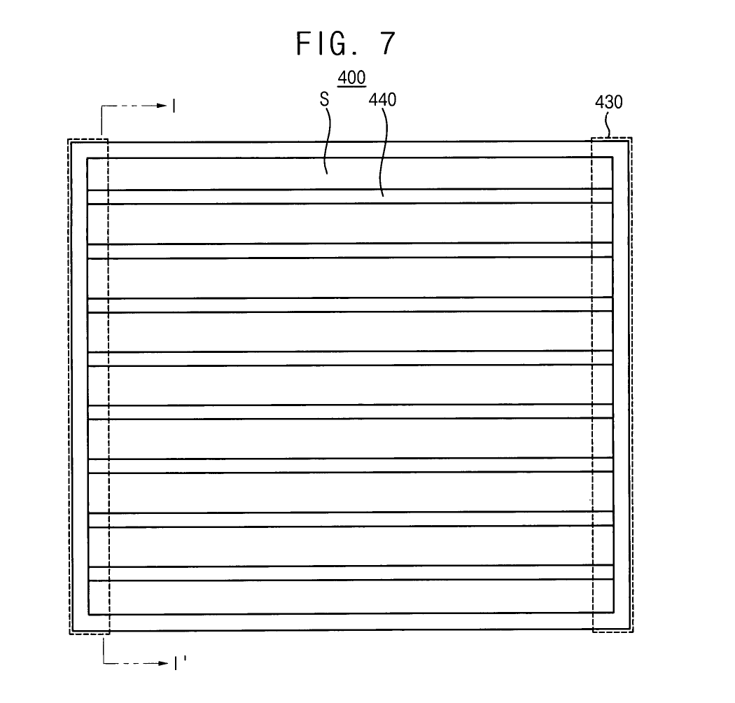

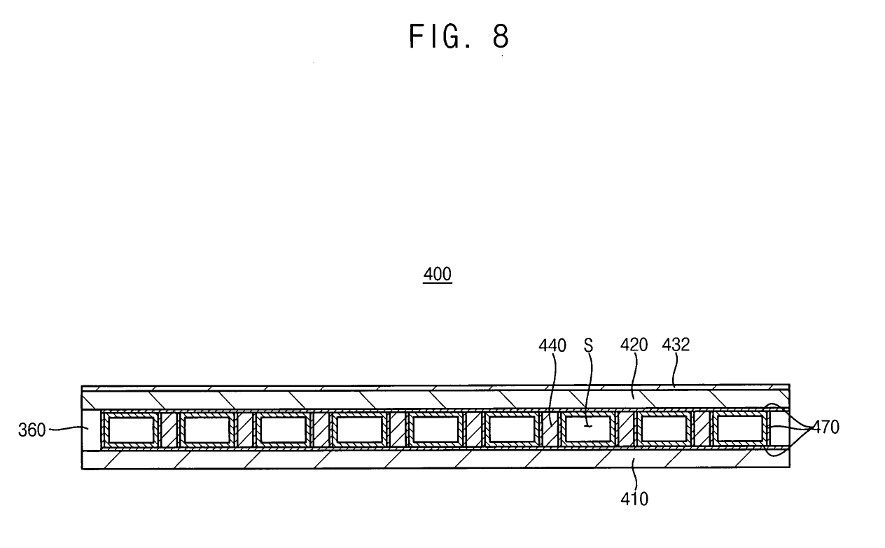

FIG. 7 is a plan view illustrating a surface light source device in accordance with a fifth embodiment of the present invention, and FIG. 8 is a cross sectional view taken along a line I-I′ in FIG. 7.

Referring to FIGS. 7 and 8, a surface light source device 400 of the present embodiment includes a first substrate 410, a second substrate 420 and an electrode 432. The first and second substrates 410 and 420 include a sodalime glass. Alternatively, any one of the first and second substrates 410 and 420 may include a sodalime glass. The second substrate 420 is positioned over the first substrate 410 to form an inner space between the first and second substrates 410 and 420.

The electrode 432 is formed on both side portions 430 of the second substrate 420. Alternatively, the electrode 432 may be formed on each of both side portions of the first and second substrates 410 and 420.

Partition walls 440 are parallely arranged in the inner space to form a plurality of discharge spaces S into which a discharge gas is injected. Examples of the discharge gas include an argon gas, a neon gas, a mercury gas, etc. Here, the partition walls 440 may include a sodalime glass substantially identical to that used as the first and second substrates 410 and 420. Alternatively, the partition walls 440 may include ceramic. A sealing member 460 for defining the inner space is interposed between edges of the first and second substrates 410 and 420.

An ion-exchanging layer 470 containing potassium ions that are exchanged for sodium ions in a sodalime glass is formed on surfaces of the first and second substrates 410 and 420, and the partition walls 440 where the electrode 432 is positioned. Additionally, a protection layer (not shown) having a thickness of about 300 Å to about 1,100 Å may be formed on the ion-exchanging layer 470. The protection layer suppresses a reaction between potassium ions and mercury and an infiltration of mercury.

Here, when an initial voltage of about 1.8 kV is applied to the surface light source device 400, preventing the ion-exchanging layer 470 from being damaged is required. Thus, to meet the above-mentioned condition, the ion-exchanging layer 470 may have a thickness of about 15 μm to about 20 μm.

### EMBODIMENT 6

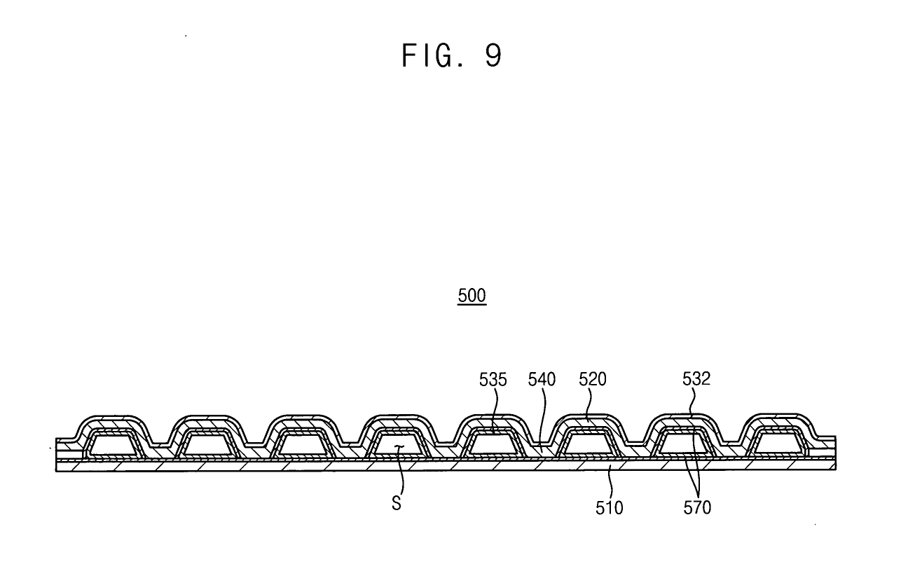

FIG. 9 is a cross sectional view illustrating an electrode of a surface light source device in accordance with a sixth embodiment of the present invention.

Referring to FIG. 9, a surface light source device 500 of the present embodiment includes a first substrate 510, a second substrate 520 and an electrode 532. The first and second substrates 510 and 520 include a sodalime glass. Alternatively, the first substrate 510 may include a borosilicate glass and the second substrate 520 may include a sodalime glass. A plurality of partition wall portions 540 is integrally formed with the second substrate 520 to define discharge spaces S into which a discharge gas is injected. Examples of the discharge gas include an argon gas, a neon gas, a mercury gas, etc. The electrode 532 is formed on the first and second substrates 510 and 520. The electrode 532 is firmly attached to a wavelike structure of the second substrate 520.

An ion-exchanging layer 570 containing potassium ions that are exchanged for sodium ions in a sodalime glass is formed on surfaces of the first and second substrates 510 and 520 where the electrode 532 is positioned. Here, when an initial voltage of about 1.8 kV is applied to the surface light source device 500, preventing the ion-exchanging layer 570 from being damaged is required. Thus, to meet the above-mentioned condition, the ion-exchanging layer 570 may have a thickness of about 15 μm to about 20 μm.

Meanwhile, according to the surface light source device 500 of the present embodiment, an additional process for forming the ion-exchanging layer 570 is not needed so that a process for manufacturing the surface light source device 600 may be efficient.

Additionally, a protection layer 535 having a thickness of about 300 Å to about 1,100 Å may be formed on the ion-exchanging layer 570. The protection layer suppresses a reaction between potassium ions and mercury and an infiltration of mercury.

Although the protection layer 535 protects portions of the first and second substrates 510 and 520 where the electrode 532 does not exist to prevent a reaction between mercury and sodium, a portion of the protection layer 535 where the electrode 535 exists may be damaged due to a high electric field generated from the electrode 535. However, since the surface light source device 500 includes the ion-exchanging layer 570, a discoloring of the surface light source device 500 caused by an elution of sodium from the surface portions of the first and second substrates 510 and 520 may be prevented.

### EMBODIMENT 7

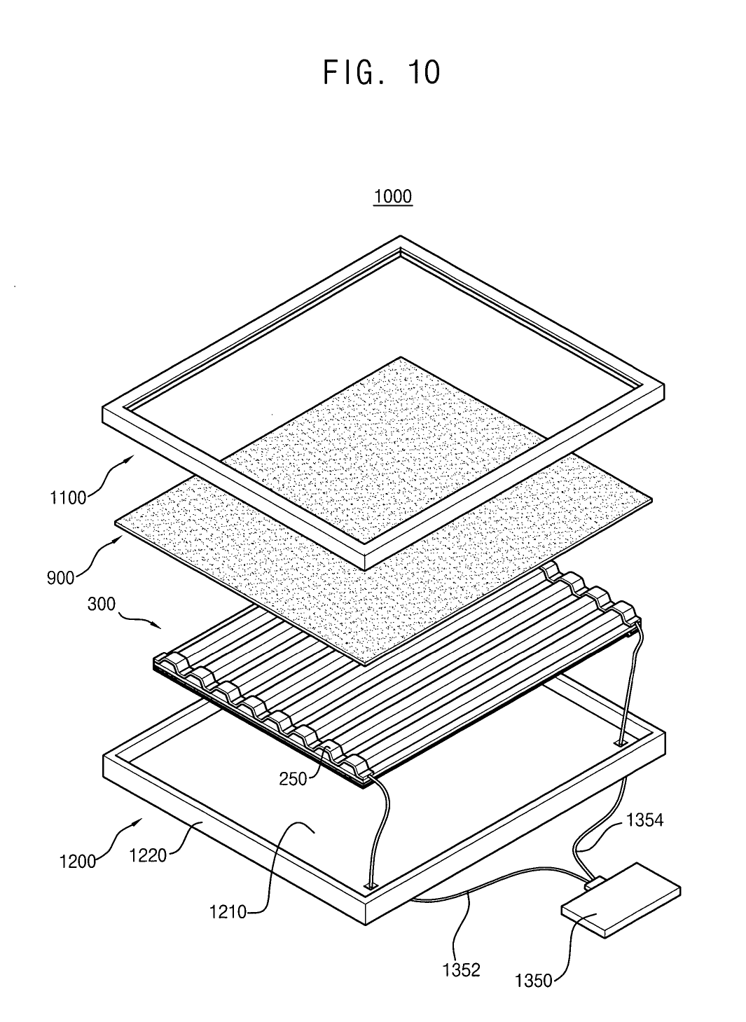

FIG. 10 is an exploded perspective view illustrating a backlight assembly in accordance with a seventh embodiment of the present invention.

Referring to FIG. 10, a backlight assembly 1000 in accordance with present embodiment includes the surface light source device 300 according to the Embodiment 4, upper and lower cases 1100 and 1200, an optical sheet 900 and an inverter 1300.

Elements of the surface light source device 300 are previously illustrated with reference to FIG. 5. Thus, any further explanation for the elements will be omitted. Meanwhile, other surface light source devices in accordance with Embodiments 1, 2, 3, 5 and 6 may be employed in the backlight assembly 1000.

The lower case 1200 includes a bottom face 1210 on which the surface light source device 300 is disposed, and sidewalls 1220 extending from edges of the bottom face 1210. A space for receiving the surface light source device 300 is defined by the bottom face 1210 and the sidewalls 1220.

The inverter 1300 is disposed beneath the lower case 1200. The inverter 1300 generates a voltage for driving the surface light source device 300. The voltage is applied to the electrode 250 of the surface light source device 300 through first and second cables 1352 and 1354.

The optical sheet 900 may include a diffusion sheet (not shown) for uniformly diffusing a light that is irradiated from the surface light source device 300, and a prism sheet (not shown) for providing straightforwardness to the diffusing light.

The upper case 1100 is combined with the lower case 1200 to support the surface light source device 300 and the optical sheet 900. Particularly, the upper case 110 prevents separation of the surface light source device 300 from the lower case 1200. Additionally, an LCD panel (not shown) may be disposed over the upper case 1100.

Evaluating Properties of Sodalime Glass Substrates

Properties of the conventional non-ion exchanged sodalime glass substrate and the ion-exchanged sodalime glass substrate in Embodiment 1 were measured. In particular, strengths of each of the sodalime glass substrates were measured using a universal testing machine (UTM). Three-point strengths on each of the sodalime glass substrates were also measured to obtain a rate of the strengths between the sodalime glass substrates. Further, surface roughnesses of each of the sodalime glass substrates were measured using an atomic force microscope (ATM) to recognize surface undulations and corrosions of the sodalime glass substrates.

The measured properties are shown in the following Table.

TABLE

| | Bending | Surface | Thickness of | |
|---|---|---|---|---|
| | strength | undulations | ion-exchanging | Rate of |
| | (kg/cm2) | (μm) | layer | strength |
| Non-ion | 760 | 0.25 | — | 1.0 |
| exchanged | | | | |
| sodalime glass | | | | |
| substrate | | | | |
| Ion exchanged | 3.140 | 0.19 | 18 | 3.7 |
| sodalime glass | | | | |
| substrate | | | | |

As shown in Table, it shall be noted that the ion-exchanged sodalime glass substrate has strength of about 3.7 times that of the non-ion exchanged sodalime glass substrate.

According to the present invention, the sodalime glass substrate containing the potassium ions that are exchanged for the sodium ions is employed in the surface light source device so that the discoloring of the surface light source device due to the sodium ions may be prevented. Further, a cost for manufacturing the surface light source device may be reduced. Furthermore, the compressive stresses caused by the ion-exchanging reaction are formed in the sodalime glass substrate so that the sodalime glass substrate may have an enhanced strength.

Additionally, the protection layer protects a portion of the substrate where the electrode does not exist to prevent a reaction between mercury and sodium. On the contrary, a portion of the protection layer where the electrode exists may be damaged due to a high electric field generated from the electrode. However, according to the present invention, the ion-exchanging layer is selectively formed on the portions of the substrate corresponding to the electrode so that various problems caused by the elution of sodium may not be generated.

Having described the exemplary embodiments of the present invention and its advantages, it is noted that various changes, substitutions and alterations can be made herein without departing from the spirit and scope of the invention as defined by appended claims.

What is claimed is:

1. A sodalime glass substrate for a surface light source device, comprising an ion-exchanging layer that contains potassium ions.

2. The sodalime glass substrate of claim 1, further comprising a plurality of partition walls for defining a discharge space in the surface light source device, the partition walls being integrally formed with the sodalime glass substrate.

3. A surface light source device comprising:
a first substrate;
a second substrate positioned over the first substrate to define an inner space into which a discharge gas is injected between the first and second substrates; and
an electrode for applying a voltage to the discharge gas,
wherein any one of the first and second substrates includes an ion-exchanging layer containing potassium ions.

4. The surface light source device of claim 3, further comprising:
a sealing member interposed between edges of the first and second substrates to define the inner space; and
partition walls arranged in the inner space to divide the inner space into a plurality of discharge spaces.

5. The surface light source device of claim 4, wherein the partition walls comprise a sodalime glass containing potassium ions.

6. The surface light source device of claim 4, wherein the partition walls are integrally formed with the second substrate.

7. A surface light source device comprising:
a first substrate including a sodalime glass;
a second substrate facing the first substrate to define an inner space between the first and second substrates, the second substrate including a sodalime glass; and
an electrode provided to both side portions of the first substrate or the second substrate,
wherein an ion-exchanging layer containing potassium ions is formed at the both side portions.

8. The surface light source device of claim 7, further comprising a protection layer formed on the first and second substrates.

9. The surface light source device of claim 7, further comprising:
a sealing member interposed between edges of the first and second substrates to define the inner space; and
partition walls arranged in the inner space to divide the inner space into a plurality of discharge spaces.

10. The surface light source device of claim 9, wherein the partition walls comprise a sodalime glass, and portions of the partition walls corresponding to the electrode comprise an ion-exchanging layer containing potassium ions.

11. The surface light source device of claim 10, further comprising a protection layer formed on the ion-exchanging layer.

12. The surface light source device of claim 7, wherein partition walls for dividing the inner space into discharge spaces are integrally formed with the first substrate or the second substrate.

13. The surface light source device of claim 7, wherein the electrode encloses the both side portions of the first and second substrates.

14. The surface light source device of claim 7, wherein the ion-exchanging layer has a thickness of about 15 μm to about 20 μm.

15. A backlight assembly comprising:
a surface light source device including a first substrate, a second substrate positioned over the first substrate to define an inner space into which a discharge gas is injected between the first and second substrates, and an electrode for applying a voltage to the discharge gas, wherein any one of the first and second substrates includes an ion-exchanging layer containing potassium ions;
a case for receiving the surface light source device;
an optical sheet interposed between the surface light source device and the case; and
an inverter for applying a voltage to the electrode.

16. A backlight assembly comprising:
a surface light source device including a first substrate including a sodalime glass, a second substrate facing the first substrate to define an inner space between the first and second substrates and including a sodalime glass, and an electrode provided to both side portions of the first substrate or the second substrate, wherein an ion-exchanging layer containing potassium ions is formed at the both side portions.
a case for receiving the surface light source device;
an optical sheet interposed between the surface light source device and the case; and
an inverter for applying a voltage to the electrode.

17. A method of manufacturing a sodalime glass substrate for a surface light source device, comprising:
heating a sodalime plate glass containing sodium ions to a temperature of no less than a softening point of the sodalime plate glass;
transforming the heated sodalime plate glass to form a sodalime glass integrally having a plurality of partition walls; and
exchanging the sodium ions in surface portions of the partition walls for potassium ions with the sodalime glass being cooled.

18. The method of claim 17, wherein exchanging the sodium ions for the potassium ions comprises spraying an ion-exchanging solution containing the potassium ions on the sodalime glass at a temperature of about 440° C. to about 480° C.

19. The method of claim 18, wherein the ion-exchanging solution comprises a slurry solution mixed of a potassium nitrate solution and a zinc oxide powder, the potassium nitrate solution having a concentration less than a solubility of below about 10% by weight.

20. The method of claim 19, wherein the zinc oxide powder in the potassium nitrate solution has a concentration of about 15% to about 50% by weight.
